(19) United States
(12) Patent Application Publication
(10) Pub. No.: US 2020/0099152 A1
(43) Pub. Date: Mar. 26, 2020

(54) Terminal Fitting Structure

(71) Applicant: Yazaki Corporation, Tokyo (JP)

(72) Inventor: Jun Toyoizumi, Makinohara-shi (JP)

(73) Assignee: Yazaki Corporation, Tokyo (JP)

(21) Appl. No.: 16/545,726

(22) Filed: Aug. 20, 2019

(30) Foreign Application Priority Data
Sep. 20, 2018 (JP) 2018-175710

(51) Int. Cl. H01R 13/03; H01R 13/11

(52) U.S. Cl. CPC H01R 13/03; H01R 13/113

(57) ABSTRACT

A terminal fitting structure includes a first terminal which includes a protruding convex portion, and a second terminal to be inserted and fitted into the first terminal, the second terminal including a conducting portion which is configured to be in contact with the convex portion to be electrically connected when fitting the second terminal into the first terminal. A silver-based plating layer is formed on an outermost surface of the conducting portion. A tin-based plating layer is formed on an outermost surface of the convex portion.

### CROSS-REFERENCE TO RELATED APPLICATIONS

This application is based on and claims priority under 35 USC 119 from Japanese Patent Application No. 2018-175710 filed on Sep. 20, 2018, the contents of which are incorporated herein by reference.

### TECHNICAL FIELD

The present disclosure relates to a terminal fitting structure.

### BACKGROUND ART

In the related art, there is known a terminal fitting structure which includes a female terminal with an indent which forms a protruding contact, and a male terminal which is to be inserted and fitted to the female terminal and in which the indent slides from an initial position of fitting to a final position of fitting. In order to reduce contact resistance or to be able to withstand use in high temperature environments, silver-based plating may be applied to each terminal in the terminal fitting structure (see, for example, JP 2018-053315 A).

However, since silver is an expensive metal, it may be difficult to use silver to a portion where, for example, tin plating was originally used.

### SUMMARY OF INVENTION

The present disclosure provides a terminal fitting structure capable of reducing contact resistance while reducing a use amount of silver.

According to an aspect of a present invention, there is provided a terminal fitting structure including a first terminal which includes a protruding convex portion, and a second terminal to be inserted and fitted into the first terminal, the second terminal including a conducting portion which is configured to be in contact with the convex portion to be electrically connected when fitting the second terminal into the first terminal. A silver-based plating layer is formed on an outermost surface of the conducting portion. A tin-based plating layer is formed on an outermost surface of the convex portion.

According to the aspect of the present invention, since a silver-based plating layer is formed on an outermost surface of a conducting portion, and a tin-based plating layer is formed on an outermost surface of a convex portion, there is no need to apply silver plating to both terminals, and the use amount of silver can be reduced. Moreover, since the tin-based plating is applied to the protruding convex portion, the tin-based plating is applied to a side where an amount of scraping occurs due to sliding of the convex portion and the conducting portion is small, so that a generation amount of tin oxide generated due to scraping of tin-based plating can reduced, and an increase in contact resistance due to tin oxide can be reduced. Therefore, the contact resistance can be reduced while reducing the use amount of silver.

According to the aspect of the present invention, a terminal fitting structure capable of reducing contact resistance while reducing use amount of silver can be provided.

### BRIEF DESCRIPTION OF DRAWINGS

FIG. 1 is a view of illustrating a configuration of a terminal fitting structure according to an embodiment of the present invention.

FIG. 2 is a cross-sectional view of illustrating a state where terminals of the terminal fitting structure according to the embodiment are fitted to each other.

FIGS. 3A and 3B are partial cross-sectional views of each terminal forming the terminal fitting structure shown in FIG. 1. FIG. 3A shows a cross section of a female terminal, and FIG. 3B shows a cross section of a male terminal.

FIG. 4 is a graph of illustrating contact resistance between a tab and a convex portion.

FIG. 5 is an enlarged cross-sectional view of illustrating a contact portion between the convex portion and the tab.

### DESCRIPTION OF EMBODIMENTS

Hereinafter, the invention will be described according to a preferred embodiment. The invention is not limited to the embodiment described below, and can be appropriately modified without departing from the scope of the invention. In the embodiment described below, some configurations are not shown or described, but it goes without saying that a known or well-known technique is applied as appropriate to details of an omitted technique within a range in which no contradiction occurs to contents described below.

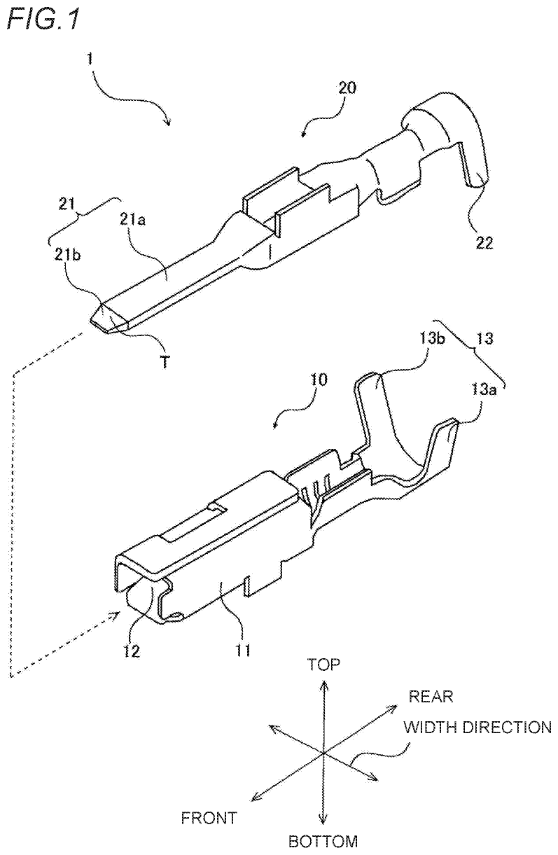

FIG. 1 is a view of illustrating a configuration of a terminal fitting structure according to an embodiment of the present invention. As shown in FIG. 1, a terminal fitting structure 1 includes a female terminal (first terminal) 10 and a male terminal 20 which is to be inserted and fitted to the female terminal 10 and includes a tab (conducting portion) 21. The terminal fitting structure 1 is formed such that these terminals 10 and 20 are fitted to each other.

The female terminal 10 is formed by bending a conductive metal punched into a predetermined shape. The female terminal 10 is accommodated and disposed in a terminal accommodating chamber of a female connector (not shown). And, the female terminal 10 includes a box portion 11, an elastic bending portion 12, and a barrel portion 13.

The box portion 11 is formed to have a square shape in which a front surface of the box portion 11 is opened by folding a conductive metal. In the box portion 11, the elastic bending portion 12 is formed to be folded rearward from a bottom surface of the box portion 11 and extend rearward slightly in a bottom-top direction.

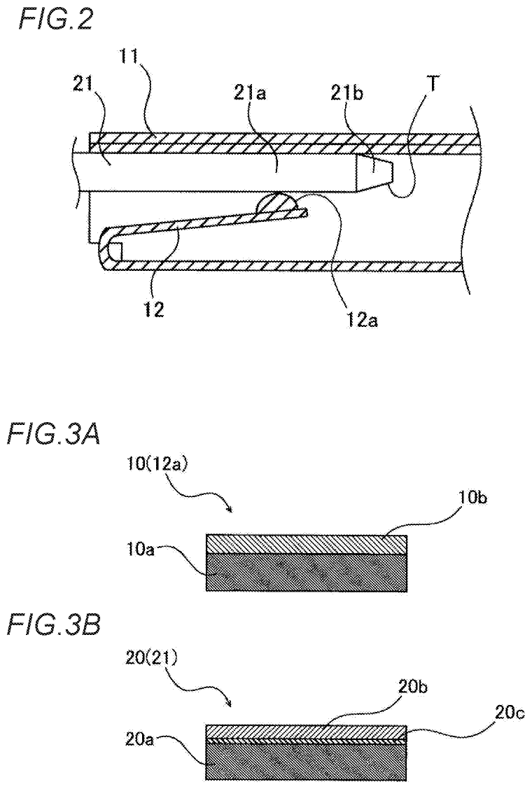

The elastic bending portion 12 is configured to bend downward with respect to the bottom surface when the tab 21 of the male terminal 20 is inserted into the box portion 11 as to be described later. The elastic bending portion 12 includes a convex portion 12a formed in a protruding shape projecting upward. See, for example, FIG. 2. When the tab 21 of the male terminal 20 is inserted into the box portion 11, the convex portion 12a is in contact with the tab 21 to secure a conductive state.

The barrel portion 13 is a plate member which is substantially U-shaped in a front view, and is a part where opposing first plate 13a and second plate 13b are bent so as to approach each other in order to crimp a conductor portion of an electric wire.

Similarly to the female terminal 10, the male terminal 20 is formed by folding a conductive metal punched into a predetermined shape. The male terminal 20 is accommodated and disposed in a terminal accommodating chamber of a male connector (not shown).

The male terminal 20 includes a tab 21 and a barrel portion 22. The tab 21 is a member whose outer shape is formed in a flat plate shape. The tab 21 includes a base portion 21a and a tip portion 21b which is located in front of the base portion 21a and is narrowed in width. The tip portion 21b is formed thinner than the base portion 21a. More specifically, the tip portion 21b is formed to have a tapered surface T which is tapered in the thickness direction of tab 21.

Similarly to the barrel portion 13 of the female terminal 10, the barrel portion 22 is a plate member which is substantially U-shaped in the front-rear direction. First and second plates faced with each other are bent so as to approach each other in order to crimp a conductor portion of an electric wire.

The female terminal 10 and the male terminal 20 as described above are fitted such that the tab 21 of the male terminal 20 is inserted into the box portion 11 of the female terminal 10 when the female connector and the male connector are fitted to each other.

FIG. 2 is a cross-sectional view of illustrating a state where the terminals of the terminal fitting structure according to the embodiment are fitted to each other.

As shown in FIG. 2, when the tab 21 of the male terminal 20 (see, for example, FIG. 1) is inserted into the box portion 11 of the female terminal 10 (see, for example, FIG. 1), the convex portion 12a is in contact with the tapered surface T of the tab 21. Then, when the male terminal 20 is further inserted rearward, the convex portion 12a passes over the tapered surface T (tip portion 21b ) while being in contact therewith to reach the base portion 21a. As a result, a fitting of the female terminal 10 and male terminal 20 is completed as shown in FIG. 2.

FIGS. 3A and 3B are partial cross-sectional views of each terminal forming the terminal fitting structure shown in FIG. 1. FIG. 3A shows a cross section of the female terminal 10, and FIG. 3B shows a cross section of the male terminal 20.

First, as shown in FIG. 3A, the female terminal 10 (in particular, convex portion 12a ) according to the present embodiment includes a copper-based metal (copper or copper alloy) served as a base material 10a and a tin-based plating layer 10b made of tin-based plating (tin or tin alloy plating) served as an outermost surface.

As shown in FIG. 3B, the male terminal 20 (in particular, tab 21) according to the present embodiment includes a copper-based metal (copper or copper alloy) served as a base material 20a and a silver-based plating layer 20b made of silver-based plating (silver or silver alloy plating) served as an outermost surface. In the male terminal 20, an intermediate layer 20c made of a nickel-based (nickel or nickel alloy) metal is formed between the base material 20a and the silver-based plating layer 20b. The intermediate layer is served as an underlayer of the silver-based plating layer 20b.

In the terminal fitting structure 1 including the female terminal 10 and the male terminal 20 according to the present embodiment, since the female terminal 10 is provided with the tin-based plating layer 10b, the use amount of silver is reduced. Further, since the tin-based plating layer 10b is formed on the female terminal 10 including the convex portion 12a, the contact resistance is reduced as compared to a case where the tin-based plating layer 10b is provided on the male terminal 20. Hereinafter, this point will be described with reference to the embodiment and comparative examples.

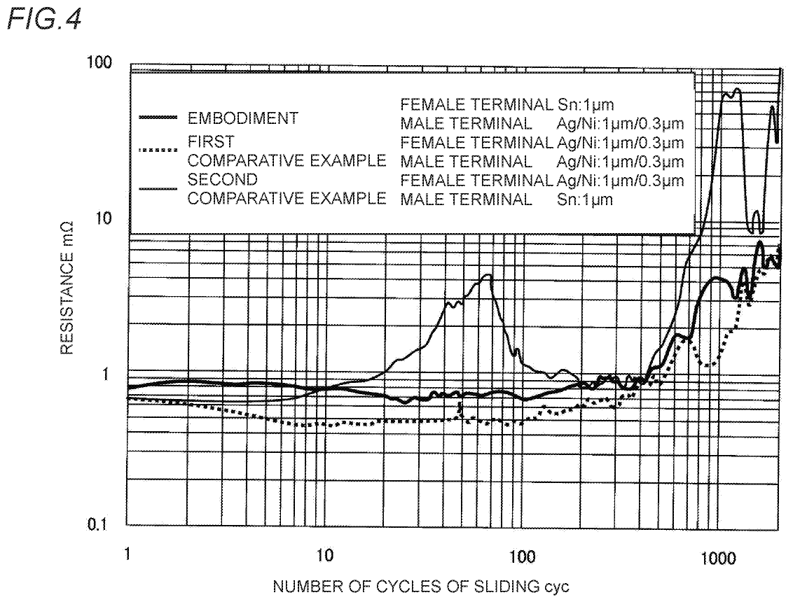

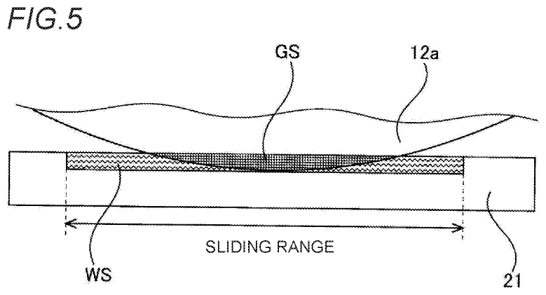

FIG. 4 is a graph of illustrating contact resistance between the tab and the convex portion. In FIG. 4, a thick solid line indicates contact resistance according to the embodiment, a broken line indicates contact resistance according to a first comparative example, and a thin solid line indicates contact resistance according to the second comparative example.

First, it is assumed that the female terminals and the male terminals according to the embodiment, the first comparative example, and the second comparative example all have the same shape.

Tin plating with a thickness of 1 μm is applied to the base material in the female terminal according to the embodiment, and silver plating with a thickness of 1 μm is applied to the base material of the male terminal via nickel with a thickness of 0.3 μm. Silver plating with a thickness of 1 μm is applied to base materials of a female terminal and a male terminal according to the first comparative example via nickel with a thickness of 0.3 μm. Silver plating with a thickness of 1 μm is applied to a base material of a female terminal according to the second comparative example via nickel with a thickness of 0.3 μm and tin plating with a thickness of 1 μm is applied to a base material of a male terminal.

In the present embodiment, the first comparative example, and the second comparative example, a value of contact resistance with respect to the number of cycles of reciprocated sliding was measured when the convex portion and the tab are slid under sliding conditions of a load of 2 N, a sliding distance of 50 μm, and a sliding speed of 100 μm/sec.

Tolerance of the thickness of each of the plating in the embodiment, the first comparative example, and the second comparative example is within ±5% thereof.

First, in the first comparative example, since silver plating was applied to both the female terminal and the male terminal, the contact resistance was generally smaller than that of the embodiment and that of the second comparative example.

Specifically, values of the contact resistance (comparison values) in the first comparative example were 0.6675 mΩ, 0.459 mΩ, 0.4755 mΩ, 0.4895 mΩ, 0.4965 mΩ, 0.5395 mΩ, 0.505 mΩ, 0.4925 mΩ, 0.473 mΩ, 0.492 mΩ and 0.4965 mΩ, respectively, when the number of the cycles of reciprocated sliding were 1, 10, 20, 30, 40, 50, 60, 70, 80, 90, and 100. Values of the contact resistance were 0.652 mΩ, 0.614 mΩ, 0.9705 mΩ, 0.866 mΩ, 1.3605 mΩ, 1.7465 mΩ, 1.2155 mΩ, 1.164 mΩ, 1.3365 mΩ, and 11.1485 mΩ, respectively, when the number of the cycles of reciprocated sliding were 200, 300, 400, 500, 600, 700, 800, 900, 1000 and 2000.

In the second comparative example, since tin plating is applied to the male terminal, tin is oxidized to tin oxide when being scraped during sliding. As a result, the contact resistance is increased. Therefore, an excessive increase in contact resistance was observed when the number of the cycles of reciprocated sliding was in a range of 20 or more and 100 or less and a range of 700 or more and 2,000 or less.

Specifically, values of the contact resistance in the second comparative example were 0.658 mΩ, 0.7755 mΩ, 1.018 mΩ, 1.464 mΩ, 2.7875 mΩ, 3.201 mΩ, 4.0625 mΩ, 3.093 mΩ, 1.894 mΩ, 1.292 mΩ, and 1.1805 mΩ, respectively, when the number of the cycle of reciprocated sliding were 1, 10, 20, 30, 40, 50, 60, 70, 80, 90, and 100. Values of the contact resistance were 0.8195 mΩ, 0.962 mΩ, 0.8755 mΩ, 1.522 mΩ, 2.625 mΩ, 6.2355 mΩ, 8.252 mΩ, 19.4665 mΩ, 68.908 mΩ, and 986.3015 mΩ, respectively, when the number of the cycles of reciprocated sliding were 200, 300, 400, 500, 600, 700, 800, 900, 1000 and 2000.

In the embodiment, since the tin plating is applied to the female terminal, tin is oxidized to tin oxide when being scraped during sliding. As a result, the contact resistance is increased. However, the values of the contact resistance in the embodiment were generally smaller than those in the second comparative example (in particular, the values of the contact resistance were smaller than those of the second comparative example in the entire range where the number of the cycles of reciprocated sliding is 20 or more and 100 or less and the number of the cycles of reciprocated sliding is 500 or more and 2000 or less).

Specifically, values of the contact resistance (measurement values) in the embodiment were 0.783 mΩ, 0.7715 mΩ, 0.7025 mΩ, 0.67 mΩ, 0.739 mΩ, 0.727 mΩ, 0.7325 mΩ, 0.751 mΩ, 0.773 mΩ, 0.743 mΩ, and 0.654 mΩ, respectively, when the number of the cycles of reciprocated sliding were 1, 10, 20, 30, 40, 50, 60, 70, 80, 90, and 100. Values of the contact resistance were 0.863 mΩ, 0.881 mΩ, 0.8975 mΩ, 1.1685 mΩ, 1.85 mΩ, 1.723 mΩ, 3.062 mΩ, 4.2245 mΩ, 40.19 mΩ, and 4.766 mΩ, respectively, when the number of the cycles of reciprocated sliding were 200, 300, 400, 500, 600, 700, 800, 900, 1000 and 2000.

As described above, the values of the contact resistance in the embodiment were generally smaller than those in the second comparative example. At this regard, it is considered to be due to the following reasons. FIG. 5 is an enlarged cross-sectional view of illustrating a contact portion between the convex portion 12a and the tab 21.

As shown in FIG. 5, both the convex portion 12a and the tab 21 are scraped respectively when the convex portion 12a and the tab 21 slide. It is ascertained that an amount of scraping of the tab 21 is larger than an amount of scraping of the convex portion 12a as compared with the both of the amounts with respect to a certain sliding range. That is, in the convex portions 12a, scraping occurs in a grid shading region GS shown in FIG. 5, while in the tab 21, scraping occurs in both the grid shading region GS and a wavy shading region WS shown in FIG. 5.

Therefore, in the embodiment in which the tin plating is applied to the convex portion 12a, an amount of tin oxide which causes the increase of the contact resistance is relatively small, and an amount of tin oxide is relatively large in the second comparative example in which the tin plating is applied to the tab. Thus, the contact resistance in the embodiment is smaller than that in the second comparative example.

In the embodiment, although the thickness of the silver-based plating layer 20b of the tab 21 and the thickness of the tin-based plating layer 10b are 1 μm respectively, the thicknesses are not particularly limited thereto. Specifically, the thickness of the silver-based plating layer 20b and the thickness of the tin-based plating layer 10b are not limited to the above as long as the thickness is set such that the value (the value divided by the same number of the cycles of sliding) obtained by dividing the value of the contact resistance in the embodiment by the value of the contact resistance in the first comparative example is 3.0 or less over the entire range where the number of the cycles of reciprocated sliding is 1 or more and 800 or less. This is because an excessive increase in contact resistance can be reduced when the value obtained by dividing is 3.0 or less.

The thickness of the silver-based plating layer 20b and the thickness of the tin-based plating layer 10b is more preferably set such that the value obtained by dividing is 1.7 or less in the entire range where the number of the cycles of reciprocated sliding is 1 or more and 200 or less rather than the case where the value obtained by dividing is 3.0 or less in the entire range where the number of the cycles of reciprocation sliding is 1 or more and 800 or less. For example, since it is considered that the number of the cycles of reciprocated sliding is about 100 in an environment inside an automobile, the increase in contact resistance can be further reduced in the intended use environment if the thickness is set such that the value obtained by dividing in the entire range of 1 or more and 200 or less is 1.7 or less.

In this way, according to the terminal fitting structure 1 of the present embodiment, since the silver-based plating layer 20b is formed on the outermost surface of the tab 21 and the tin-based plating layer 10b is formed on the outermost surface of the convex portion 12a, there is no need to apply silver plating to both terminals 10 and 20, and the use amount of silver can be reduced. Moreover, since the tin-based plating is applied to the protruding convex portion 12a, and the tin-based plating is applied to a side where an amount of scraping occurs due to the sliding of the convex portion and the tab is small, so that a generation amount of the tin oxide generated due to scraping of tin-based plating can reduced, and an increase in contact resistance due to tin oxide can be reduced. Therefore, the contact resistance can be reduced while reducing the use amount of silver.

In the male terminal 20, since the base material 20a is a copper-based metal, and the nickel-based intermediate layer 20c is interposed between the silver-based plated layer 20b on the outermost surface and the base material 20a, the plating process of the silver-based plating layer 20b which is difficult to be plated to copper can be facilitated by interposing the nickel-based intermediate layer 20c.

The thickness of the silver-based plating layer 20b and the thickness of the tin-based plating layer 10b of the convex portion 12a is set such that the value obtained by dividing the value of contact resistance by the value of contact resistance to be compared is 3.0 or less over the entire range where the number of the cycles of reciprocated sliding is 1 or more and 800 or less. Therefore, the silver-based plating and the tin-based plating are applied such that the value of the contact resistance is 3 times or less of that as compared with the case in which both the outermost surfaces are silver plating, the use amount of silver can be reduced while reducing an excessive increase in contact resistance due to the use of tin-based plating.

The thickness of the silver-based plating layer 20b and the thickness of the tin-based plating layer 10b of the convex portion 12a is set such that the value obtained by dividing the value of contact resistance by the value of contact resistance to be compared is 3.0 or less over the entire range where the number of the cycles of reciprocated sliding is 1 or more and 800 or less. Therefore, the silver-based plating and the tin-based plating are applied such that the contact resistance value is 3 times or less of that to be compared in which both the outermost surfaces are silver plating, the use amount of silver can be reduced while reducing an excessive increase in contact resistance due to the use of tin-based plating.

The invention is described based on the above embodiment. The invention is not limited to the embodiment described above, and may be modified without departing from the scope of the invention. Furthermore, the invention may be appropriately combined with another technique within a feasible configuration thereof.

In the present embodiment, although the tab 21 has the tapered surface T on both the upper surface and the lower surface thereof, the present invention is not limited thereto. That is, the tab 21 may not have the tapered surface T, or may have the tapered surface T only on one surface thereof.

Further, the base material 20a and the intermediate layer 20c are not limited to copper-based metals and nickel-based metals, and other metals may be used.

### REFERENCE SIGNS LIST

1 terminal fitting structure

10 female terminal (first terminal)

10a base material

10b tin-based plating layer

12a convex portion

20 male terminal (second terminal)

20a base material

20b silver-based plating layer

20c intermediate layer

21 tab (conducting portion)

What is claimed is:

1. A terminal fitting structure, comprising:
a first terminal which includes a protruding convex portion; and
a second terminal to be inserted and fitted into the first terminal, the second terminal including a conducting portion which is configured to be in contact with the convex portion to be electrically connected when fitting the second terminal into the first terminal,
wherein a silver-based plating layer is formed on an outermost surface of the conducting portion, and
wherein a tin-based plating layer is formed on an outermost surface of the convex portion.

2. The terminal fitting structure according to claim 1,
wherein a base material of the second terminal is made of a copper-based metal, and a nickel-based intermediate layer is interposed between the silver-based plating layer on the outermost surface and the base material.

3. The terminal fitting structure according to claim 2,
wherein a thickness of the silver-based plating layer of the conducting portion and a thickness of the tin-based plating layer of the convex portion are designed such that a value obtained by dividing a measurement value by a comparative value does not exceed 3.0 over an predetermined range,
wherein the measurement value is a contact resistance between the conducting portion and the convex portion measured when the convex portion of the first terminal and the conducting portion of the second terminal are slid in a reciprocated manner under conditions of a load of 2 N, a sliding distance of 50 μm, and a sliding speed of 100 μm/sec,
wherein the predetermined range is a range of a number of cycles of a reciprocated sliding between 1 or more and 800 or less,
wherein the comparative value is a contact resistance between a comparative convex portion and a comparative conducting portion measured when the comparative convex portion and the comparative conducting portion are slid in a reciprocated manner under conditions of a load of 2N, a sliding distance of 50 μm, and a sliding speed of 100 μm/sec,
wherein, the comparative convex portion includes a nickel-based intermediate layer formed on a base material and a silver-based plating layer formed on the nickel-based intermediate layer,
wherein the comparative conducting portion includes a nickel-based intermediate layer formed on a base material and silver-based plating layer formed on the nickel-based intermediate layer,
wherein a thickness of the nickel-based intermediate layer of the comparative convex portion is 0.3 μm,
wherein a thickness of the silver-based plating layer on an outermost surface of the comparative convex portion is 1 μm,
wherein a thickness of the nickel-based intermediate layer of the comparative conducting portion is 0.3 μm, and
wherein a thickness of the silver-based plating layer on an outermost surface of the comparative conducting portion is 1 μm.
